(19) United States
(12) Patent Application Publication
(10) Pub. No.: US 2022/0254082 A1
(43) Pub. Date: Aug. 11, 2022

(54) METHOD OF CHARACTER ANIMATION BASED ON EXTRACTION OF TRIGGERS FROM AN AV STREAM

(71) Applicant: Sony Interactive Entertainment Inc., Tokyo (JP)

(72) Inventors: Udupi Ramanath Bhat, Los Altos, CA (US); Daisuke Kawamura, Foster City, CA (US)

(21) Appl. No.: 17/168,727

(22) Filed: Feb. 5, 2021

(51) Int. Cl. G06T 13/40; G06T 13/80; H04N 21/84; H04N 21/61; H04N 21/81; H04N 21/478; A63F 13/52

(52) U.S. Cl. CPC G06T 13/40; G06T 13/80; H04N 21/84; A63F 13/52; H04N 21/8146; H04N 21/4781; H04N 21/6125

(57) ABSTRACT

Digital events to dynamically establish avatar emotion may include particular dynamic metadata happening on live TV, Internet streamed video, live computer gameplay, movie scene, particular voice trigger from users or spectators, the dynamic position/state of an input device (such as a game controller resting on a table), etc. The system dynamically changes the state of a user avatar to various emotional and rig transformation state through this smart system. This brings in more life to the existing static chat/video chat conversation which is active, and user driven while this system is dynamically trigger-driven and autonomous in nature. The avatar world is thus rendered to ne more life-like and responsive to environmental and digital happenings of the user.

### FIELD

The application relates generally to dynamic emotion trigger user experiences (UX) for multi modal avatar communication systems.

### BACKGROUND

With the growing demand of people broadcasting/sharing their presence on the internet and the overwhelming growth of users wanting to use their favorite avatar or emoji to express their emotions, present principles recognize that a dynamic multi-modal trigger system in which avatar emotions are influenced or predicted dynamically based on a digital event or artificial intelligence can be attractive.

### SUMMARY

Digital events to dynamically establish avatar emotion may include particular dynamic metadata happening on live TV, live computer gameplay, movie scene, particular voice trigger from users or spectators, the dynamic position/state of an input device (such as a game controller resting on a table), camera gesture, song lyrics, etc. The system dynamically changes the state of a user avatar to various emotional and rig transformation state through this smart system. This brings in more life to the existing static chat/video chat conversation which is active, and user driven while this system is dynamically trigger-driven and autonomous in nature thus making it more entertainment value. The avatar world is thus rendered to be more life-like and responsive to environmental and digital happenings of the user. The system can automatically assign avatar emotions based on an output (sad, shot, happy, celebrating, etc.)

Accordingly, an apparatus includes at least one computer storage that is not a transitory signal and that in turn includes instructions executable by at least one processor to receive metadata including one or more of TV metadata, camera motion metadata, computer gameplay metadata, song lyrics, computer input device motion information. The instructions are executable to, based at least in part on the metadata, animate at least one emoji or avatar that is not a computer game character.

In some embodiments the emoji or avatar is a first emoji or avatar, and the instructions may be executable to identify at least a first user associated with at least the first emoji or avatar and animate the first emoji or avatar based at least in part on the identification of the first user and the metadata. The instructions further may be executable to identify at least a second user associated with a second emoji or avatar, and animate the second emoji or avatar based at least in part on the identification of the second user and the metadata, such that the first emoji or avatar is animated differently than the second emoji or avatar and both emoji or avatars are animated based at least in part on same metadata.

In example implementations the instructions may be executable to identify whether the metadata satisfies a threshold or gets assigned higher priority in the multi modal system, and animate the emoji or avatar based at least in part on the metadata responsive to the metadata satisfying the threshold, and otherwise not animate the emoji or avatar responsive to the metadata not satisfying the threshold.

In some examples the metadata is first gameplay metadata from a first computer game, and the instructions can be executable to receive second gameplay metadata from a second computer game. The second computer game is different from the first computer game, but the first gameplay metadata represents the same information as represented by the second gameplay metadata. The instructions may be executable to animate the emoji or avatar in a first way responsive to the first gameplay metadata and animate the emoji or avatar in a second way different from the first way responsive to the second gameplay metadata.

In another aspect, an assembly includes at least one processor programmed with instructions to, during play of a computer game, receive from the computer game metadata representing action in the computer game, and animate, in accordance with the metadata, at least one avatar or emoji that is not a character in the action of the computer game.

In another aspect, a method includes receiving metadata from a first source of metadata and determining whether the metadata satisfies a threshold. The method includes, responsive to determining that the metadata satisfies the threshold, animating a first avatar or emoji in accordance with the metadata, whereas responsive to determining that the metadata does not satisfy the threshold, not animating the first avatar or emoji in accordance with the metadata.

The details of the present application, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system showing computer components some or all of which may be used in various embodiments;

FIG. 2 illustrates avatar presentation while schematically showing an example machine learning (ML) module that can be used to animate avatars;

FIG. 3 illustrates example ML module training logic in example flow chart format;

FIG. 4 illustrates example avatar animation logic in example flow chart format using live TV metadata;

FIG. 5 illustrates example avatar animation logic in example flow chart format using computer simulation metadata such as computer game metadata;

FIG. 6 illustrates example avatar animation logic in example flow chart format using song lyric metadata;

FIG. 7 illustrates example avatar animation logic in example flow chart format using input device motion metadata;

FIG. 8 illustrates example specific avatar animation logic in example flow chart format;

FIG. 9 illustrates further principles of avatar animation based on computer game metadata; and

FIG. 10 illustrates further principles of avatar animation based on computer game metadata.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

A processor may be a single- or multi-chip processor that can execute logic by means of various lines such as address lines, data lines, and control lines and registers and shift registers.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

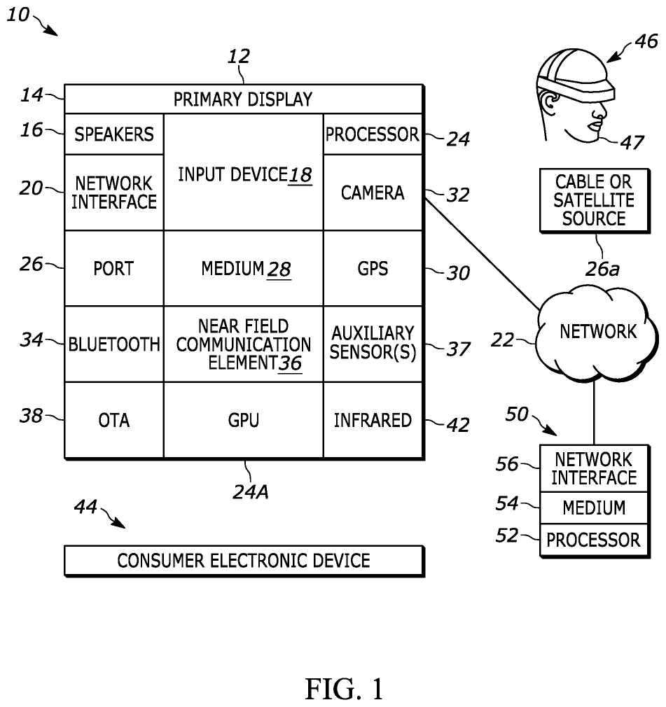

Now specifically referring to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to an Internet-enabled TV with a TV tuner (equivalently, set top box controlling a TV). The AVD 12 alternatively may also be a computerized Internet enabled (“smart”) telephone, a tablet computer, a notebook computer, a HMD, a wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some or all of the components shown in FIG. 1. For example, the AVD 12 can include one or more displays 14 that may be implemented by a high definition or ultra-high definition “4K” or higher flat screen and that may be touch-enabled for receiving user input signals via touches on the display. The AVD 12 may include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. A graphics processor 24A may also be included. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input ports 26 such as a high-definition multimedia interface (HDMI) port or a USB port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 44.

The AVD 12 may further include one or more computer memories 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24. The component 30 may also be implemented by an inertial measurement unit (IMU) that typically includes a combination of accelerometers, gyroscopes, and magnetometers to determine the location and orientation of the AVD 12 in three dimensions.

Continuing the description of the AVD 12, in some embodiments the AVD 12 may include one or more cameras 32 that may be a thermal imaging camera, a digital camera such as a webcam, and/or a camera integrated into the AVD 12 and controllable by the processor 24 to gather pictures/images and/or video in accordance with present principles. Also included on the AVD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 37 (e.g., a motion sensor such as an accelerometer, gyroscope, cyclometer, or a magnetic sensor, an infrared (IR) sensor, an optical sensor, a speed and/or cadence sensor, a gesture sensor (e.g., for sensing gesture command), providing input to the processor 24. The AVD 12 may include an over-the-air TV broadcast port 38 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12.

Still referring to FIG. 1, in addition to the AVD 12, the system 10 may include one or more other CE device types. In one example, a first CE device 44 may be a computer game console that can be used to send computer game audio and video to the AVD 12 via commands sent directly to the AVD 12 and/or through the below-described server while a second CE device 46 may include similar components as the first CE device 44. In the example shown, the second CE device 46 may be configured as a computer game controller manipulated by a player or a head-mounted display (HMD) worn by a player 47. In the example shown, only two CE devices 44, 46 are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 50, it includes at least one server processor 52, at least one tangible computer readable storage medium 54 such as disk-based or solid-state storage, and at least one network interface 56 that, under control of the server processor 52, allows for communication with the other devices of FIG. 1 over the network 22, and indeed may facilitate communication between servers and client devices in accordance with present principles. Note that the network interface 56 may be, e.g., a wired or wireless modem or router, Wi-Fi transceiver, or other appropriate interface such as, e.g., a wireless telephony transceiver.

Accordingly, in some embodiments the server 50 may be an Internet server or an entire server “farm” and may include and perform “cloud” functions such that the devices of the system 10 may access a “cloud” environment via the server 50 in example embodiments for, e.g., network gaming applications. Or the server 50 may be implemented by one or more game consoles or other computers in the same room as the other devices shown in FIG. 1 or nearby.

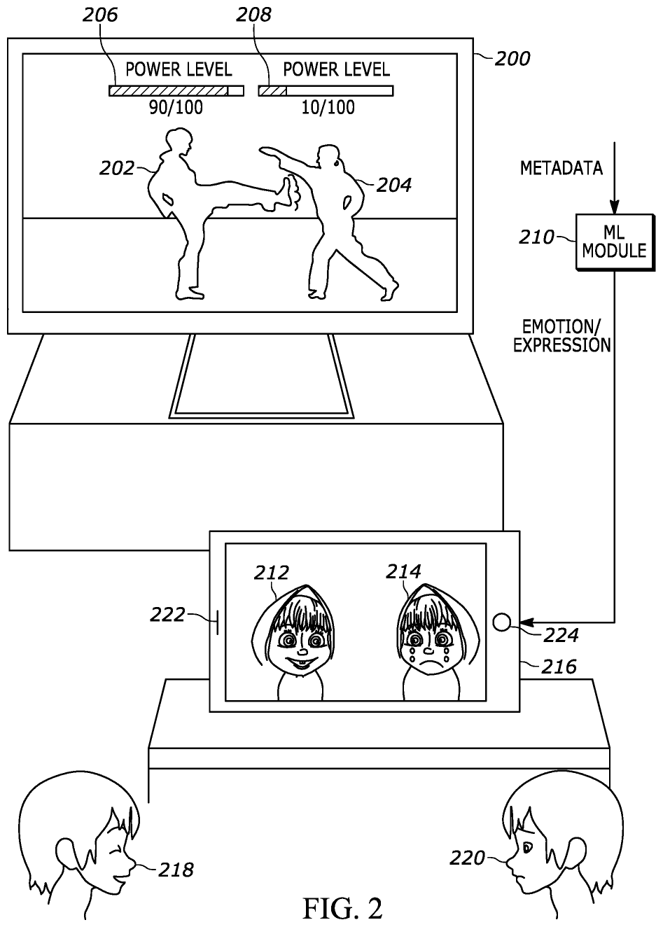

FIG. 2 illustrates present principles in schematic form. In the example shown, a computer game is being presented on a primary display 200, with a first character 202 kicking a second character 204. First metadata 206 indicates a power level of the first character 202, whereas second metadata 208 indicates a power level of the second character 204. It is to be understood that the metadata 206, 208 typically is not presented on the display, but may be. In any case, the metadata may be provided to a correlation module such as a machine learning (ML) module 210 to correlate the metadata to an emotion/expression, which is used to animate emoticons or, in the example shown, avatars 212, 214 associated with respective users who are respectively associated with the characters 202, 204. The avatars 212, 214 may be presented on the primary display 200, on separate, respective secondary displays, or in the embodiment shown, on the same secondary display 216.

It may now be appreciated that avatars and emoticons that are not part of the computer game or otherwise associated with the metadata describing the onscreen action can nonetheless be animated according to the metadata, to automatically reflect the emotion of the user associated with the avatar or emoticon. Because different users will have different emotional reactions to the same onscreen action, the animation of the avatars or emoticons can be different even though being based on the same metadata (but different user identifications.) Similarly,

In the example of FIG. 2, the first avatar 212 is illustrated with a powerful or pleased expression as befits being correlated to the high-power level of the first character 202, whereas the second avatar 214 is illustrated with a weakened, dazed expression as befits being correlated to the low power level of the second character 204.

Additionally, first and second users 218, 220 associated with the first and second characters 202, 204 (and, hence, the first and second avatars 212, 214) may be identified consistent with present principles. The users 218, 220 may be identified by means of having input their user credentials to a computer game console or other device, which credentials are linked to respective profiles, or they may be identified by voice and/or face recognition based on signals from one or more microphones 222, 224, in the example shown associated with the secondary display 216. The identifications may specifically identify the users by individual identity. Or the identifications may generically identify the users using voice or face recognition. For instance, the first user 218 may be generically identified as a fan of a particular player or team presented on the primary display 200 based on the vocal and/or physical reactions of the first user 218 to the success or failure of the particular player or team at any given point.

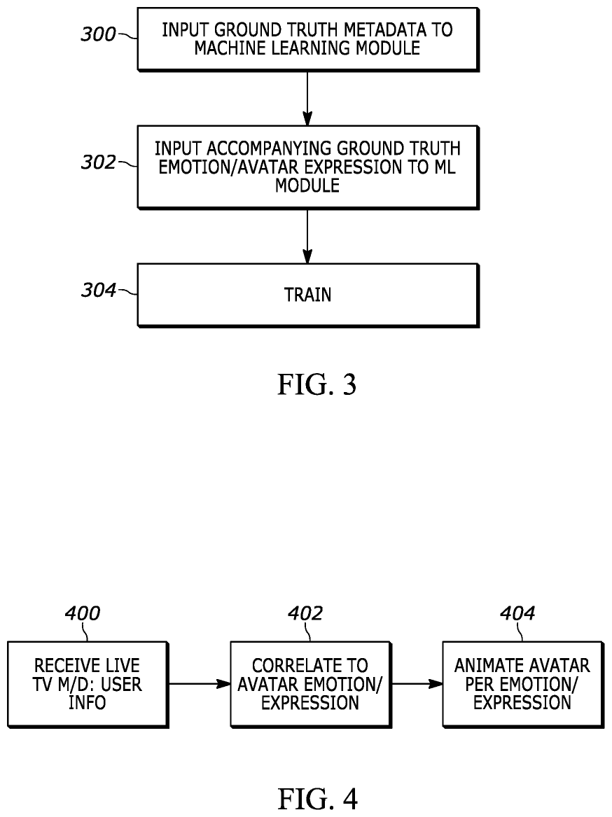

Animating avatars or emoticons based on metadata not otherwise pertaining to the avatars or emoticons may be executed by the ML module 210 if desired. FIG. 3 illustrates a simplified training logic which commences at block 300, in which ground truth metadata is input to the ML module. Associated ground truth emotion/expression is input at block 302 to train the ML module 210 at block 304.

It should be noted that an AV stream such as a gameplay stream or TV stream can be segmented by object as further described below, objects labeled, blended together if desired, and the blended metadata correlated to emotion/expression.

Note that in lieu of using machine learning, metadata may be correlated to emotions/expressions by a database or library correlating actions in AV with emotion to mimic with avatar.

FIGS. 4-7 illustrates various types of metadata that may be used to animate emoticons or avatars that are not otherwise the subject of the metadata. Commencing at block 400 in FIG. 4, metadata from TV such as live TV, including advanced television systems committee (ATSC) 3.0 metadata, may be received, e.g., by the ML module 210 shown ion FIG. 2. Based on its training, the ML module can correlate the metadata to avatar emotion/expression at block 402 and animate the avatar or emoticon at block 404 according to the emotion/expression.

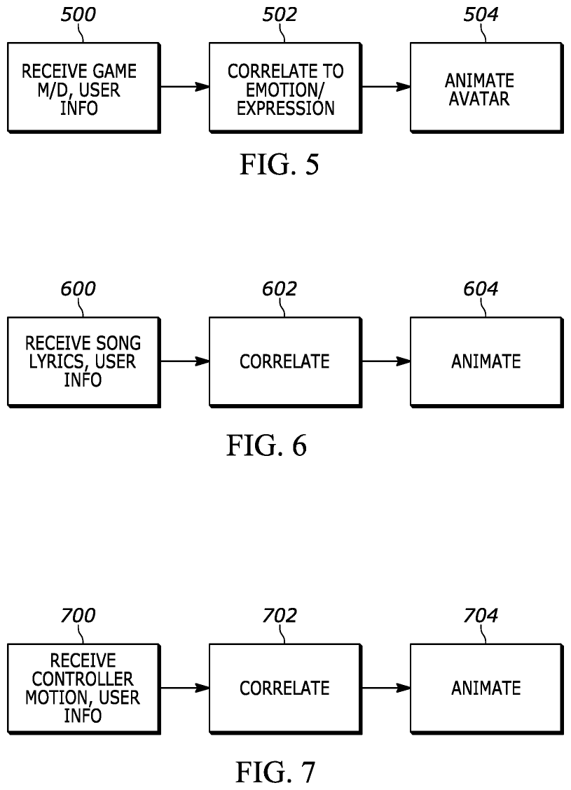

Commencing at block 500 in FIG. 5, metadata from a computer game or other computer simulation may be received, e.g., by the ML module 210 shown ion FIG. 2. Based on its training, the ML module can correlate the metadata to avatar emotion/expression at block 502 and animate the avatar or emoticon at block 504 according to the emotion/expression. Note that the logic of FIG. 5 may be triggered automatically by the start of gameplay. Or a user interface may be presented to allow a user to enable and disable the logic of FIG. 5.

Yet again, commencing at block 600 in FIG. 6, metadata representing song lyrics or other verbal utterance may be received, e.g., by the ML module 210 shown ion FIG. 2. Based on its training, the ML module can correlate the metadata to avatar emotion/expression at block 602 and animate the avatar or emoticon at block 604 according to the emotion/expression. Thus, if a user is listening to music while playing a computer game, and a particular lyric known that triggers emotions in user (“oh yeah, crank it up”), the avatar associated with the user can react to music too whether part of game or independent of game.

Yet again, commencing at block 700 in FIG. 7, metadata representing motion of a computer input device such as a computer game controller may be received, e.g., by the ML module 210 shown ion FIG. 2. Based on its training, the ML module can correlate the metadata to avatar emotion/expression at block 702 and animate the avatar or emoticon at block 704 according to the emotion/expression.

Thus, if a player slams a game controller down when angry as indicated by motion signals from the controller indicating high velocity followed by a sudden stop, a first emotion or expression may be correlated, whereas a second, different emotion/expression may be correlated to motion indicating casual one-handed use by a skilled user. Motion signals may be derived from motions sensors in the controller.

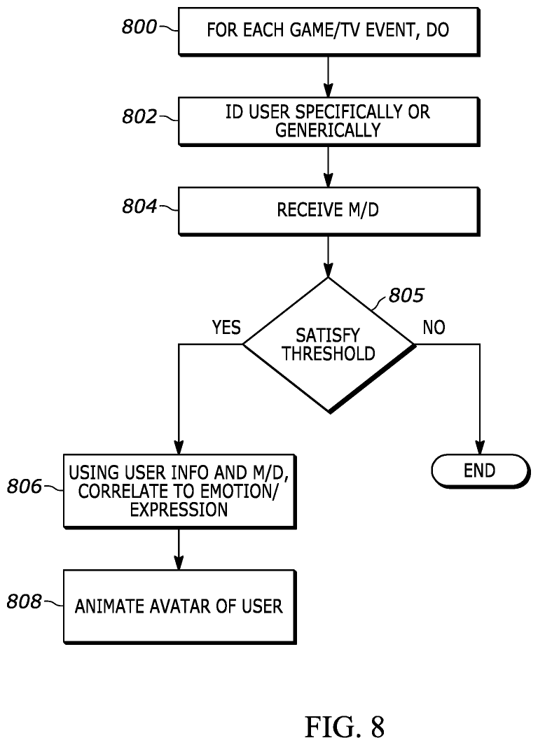

Refer now to FIG. 8, in which logic for each game or TV event, for example, may be entered at block 800. In other words, block 800 recognizes that a player after a score in a simulated athletic event, for example, may make different moves/goal celebrations, and the avatar corresponding to the user associated with the “player” can mimic those moves or celebrations too. Thus, animation rigs can be hot-swappable, and emotions/expressions of avatars or emoticons can depend on the computer game being played, for example. A game developer may build a library for this or let users swap avatars for different animations only those avatars support.

As another example, users playing soccer simulations may experience stronger emotions than users playing first person shooter games, so that different profile of emotions for different games can be used.

Moving to block 802, the user(s) is/are identified either specifically or generically as described previously. Thus, different profiles of emotions for different users may be used to drive the personalization of the avatar to the metadata, so if, for example, a user is a fan of a player and he does a good move as indicated by metadata, the user's avatar can be made to look happy, whereas if the user is a fan of the other player getting beat, that user's avatar may be made to look sad.

Metadata is received at block 804, and decision diamond 805 indicates that it may be determined whether the metadata satisfies a threshold. This is to prevent over-driving avatar animation based on spurious events. If the metadata satisfies the threshold, it is used at block 806, along with the user ID at block 802, to identify a correlative emotion or expression, which in turn is used at block 808 to animate the avatar or emoticon associated with the user identified at block 802.

Note that avatar animation may not be simply reactive but can include predictive emotion or expression based on the triggers for anticipated future events to move the avatar, so it acts at right time in the future. Also, multi-modal triggers may be present in the metadata, and in such cases some triggers can be prioritized according to empirical design criteria over others.

Among computer game metadata that may be used in FIG. 8 by way of non-limiting example are “remaining power of character”, “magic power of character”, character pose, weapons, character jump, character run, character special skills, character position.

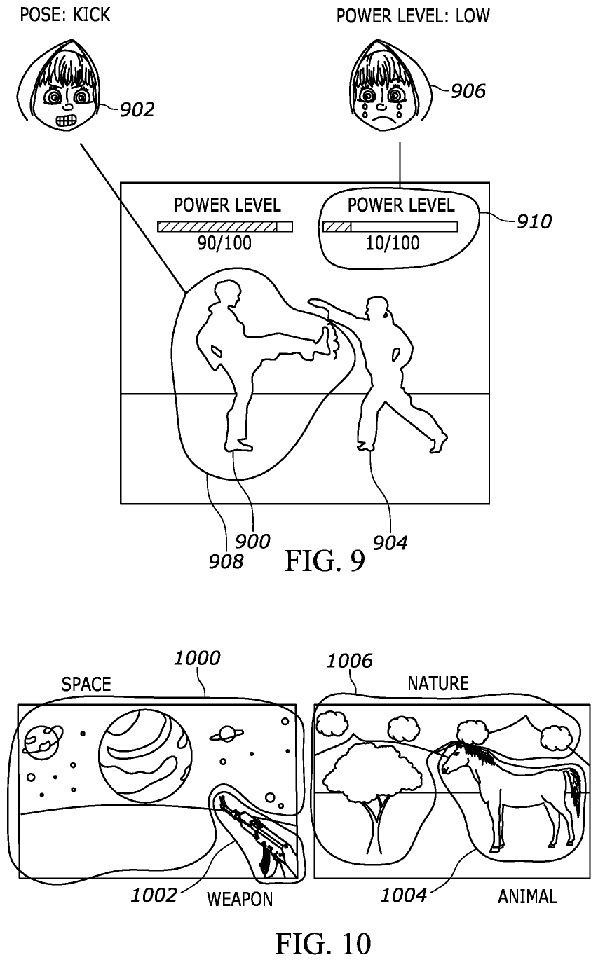

FIGS. 9 and 10 provide further graphic illustration. In FIG. 9, a first game character 900 is associated with a first user with associated avatar 902 and a second game character 904 is associated with a second user with associated second avatar 906. Metadata indicated by the enclosed area 908 around the first character 900 indicates a string kick and hence the expression of the first avatar 902 is animated to be aggressive. Metadata 910 indicating a low power level of the second character 904 is correlated to an exhausted expression with which to animate the second avatar 906.

FIG. 10 illustrates additional types of metadata from an Av stream that may be used to animate avatars or emoticons, including space 1000, weapons 1002, animals 1004, and nature scenes 1006.

Profiling side for predictions—over the years, you can get a profile of user emotion and store that, could be very valuable to advertisers, social media companies, etc. so they know not just that you react to something but HOW you react to something.

It will be appreciated that whilst present principals have been described with reference to some example embodiments, these are not intended to be limiting, and that various alternative arrangements may be used to implement the subject matter claimed herein.

What is claimed is:

1. An apparatus comprising:
at least one computer storage that is not a transitory signal and that comprises instructions executable by at least one processor to:
receive metadata comprising one or more of TV metadata, computer gameplay metadata, song lyrics, computer input device motion information; and
based at least in part on the metadata, animate at least one emoji or avatar that is not a computer game character.

2. The apparatus of claim 1, wherein the metadata comprises TV metadata.

3. The apparatus of claim 1, wherein the metadata comprises Internet streaming video content metadata.

4. The apparatus of claim 1, wherein the metadata comprises computer gameplay metadata.

5. The apparatus of claim 1, wherein the metadata comprises song lyrics.

6. The apparatus of claim 1, wherein the metadata comprises computer input device motion information.

7. The apparatus of claim 1, wherein the emoji or avatar is a first emoji or avatar, and the instructions are executable to:
identify at least a first user associated with at least the first emoji or avatar;
animate the first emoji or avatar based at least in part on the identification of the first user and the metadata;
identify at least a second user associated with a second emoji or avatar; and
animate the second emoji or avatar based at least in part on the identification of the second user and the metadata, such that the first emoji or avatar is animated differently than the second emoji or avatar and both emoji or avatars are animated based at least in part on same metadata.

8. The apparatus of claim 1, wherein the instructions are executable to:
identify whether the metadata satisfies a threshold or assigned highest priority in a multi modal system; and
animate the emoji or avatar based at least in part on the metadata responsive to the metadata satisfying the threshold, and otherwise not animate the emoji or avatar responsive to the metadata not satisfying the threshold.

9. The apparatus of claim 1, wherein the metadata is first gameplay metadata from a first computer game, and the instructions are executable to:
receive second gameplay metadata from a second computer game, the second computer game being different from the first computer game, the first gameplay metadata representing a same information as represented by the second gameplay metadata;
animate the emoji or avatar in a first way responsive to the first gameplay metadata; and
animate the emoji or avatar in a second way different from the first way responsive to the second gameplay metadata.

10. The apparatus of claim 1, comprising the at least one processor and at least one computer game component containing the at least one processor.

11. An assembly comprising:
at least one processor programmed with instructions to:
during play of a computer game, receive from the computer game metadata representing action in the computer game; and
animate, in accordance with the metadata, at least one avatar or emoji that is not a character in the action of the computer game.

12. The assembly of claim 11, comprising at least one computer game component containing the at least one processor.

13. The assembly of claim 11, wherein the avatar is a first avatar or emoji, and the instructions are executable to:
identify at least a first user associated with at least the first avatar or emoji;
animate the first avatar or emoji based at least in part on the identification of the first user and the metadata;
identify at least a second user associated with a second avatar or emoji; and
animate the second avatar or emoji based at least in part on the identification of the second user and the metadata, such that the first avatar or emoji is animated differently than the second avatar or emoji and both avatars or emoji are animated based at least in part on same metadata.

14. The assembly of claim 11, wherein the instructions are executable to:
identify whether the metadata satisfies a threshold; and
animate the avatar or emoji based at least in part on the metadata responsive to the metadata satisfying the threshold, and otherwise not animate the avatar or emoji responsive to the metadata not satisfying the threshold.

15. The assembly of claim 11, wherein the metadata is first gameplay metadata from a first computer game, and the instructions are executable to:
receive second gameplay metadata from a second computer game, the second computer game being different from the first computer game, the first gameplay metadata representing a same information as represented by the second gameplay metadata;
animate the avatar or emoji in a first way responsive to the first gameplay metadata; and
animate the avatar or emoji in a second way different from the first way responsive to the second gameplay metadata.

16. A method, comprising:
receiving metadata from a first source of metadata;
determining whether the metadata satisfies a threshold;
responsive to determining that the metadata satisfies the threshold, animating a first avatar or emoji in accordance with the metadata; and
responsive to determining that the metadata does not satisfy the threshold, not animating the first avatar or emoji in accordance with the metadata.

17. The method of claim 16, wherein the metadata comprises gameplay metadata from a computer game, and the first avatar or emoji is not a character to which the gameplay metadata applies in the computer game.

18. The method of claim 17, comprising:
animating the first avatar or emoji in accordance with the metadata in a first way correlated to identifying a first user; and
animating the first avatar or emoji in accordance with the metadata in a second way correlated to identifying a second user.

19. The method of claim 17, wherein the metadata is first gameplay metadata from a first computer game, and the method comprises:
receiving second gameplay metadata from a second computer game, the second computer game being different from the first computer game, the first gameplay metadata representing a same information as represented by the second gameplay metadata;
animating the avatar or emoji in a first way responsive to the first gameplay metadata; and
animating the avatar or emoji in a second way different from the first way responsive to the second gameplay metadata.
